(19) United States
(12) Patent Application Publication
(10) Pub. No.: US 2024/0354627 A1
(43) Pub. Date: Oct. 24, 2024

(54) QUANTUM ALGORITHM ASSISTANT

(71) Applicant: Dell Products L.P., Round Rock, TX (US)

(72) Inventors: Rômulo Teixeira de Abreu Pinho, Niterói (BR); Miguel Paredes Quiñones, Campinas (BR); Brendan Burns Healy, Haddonfield, NJ (US)

(21) Appl. No.: 18/345,244

(22) Filed: Jun. 30, 2023

Related U.S. Application Data
(60) Provisional application No. 63/383,347, filed on Nov. 11, 2022.

(51) Int. Cl. G06N 10/60; G06N 10/20

(52) U.S. Cl. CPC G06N 10/60; G06N 10/20

(57) ABSTRACT

One example method includes detecting a quantum gate pattern in a quantum circuit, analyzing the quantum gate pattern, based on the analyzing, generating a set of rules and generating a modified quantum gate pattern that comprises a modification of the quantum gate pattern, based on the modified quantum gate pattern, generating a set of transpilation output metrics, and using the rules and the transpilation output metrics to generate a suggestion concerning modification of the quantum circuit.

### FIELD OF THE INVENTION

Some embodiments of the present invention generally relate to quantum computing. More particularly, at least some embodiments of the invention relate to systems, hardware, software, computer-readable media, and methods, for quantum computing transpilation processes.

### BACKGROUND

Transpilation considers topological aspects of hardware, and overall noise in a system, to find optimal mappings from logical to physical circuits. Since transpilation is implemented via heuristic algorithms, the initial conditions, that is, the logical circuit, directly determine the quality and speed of transpilation outcomes.

Quantum algorithm developers typically write their logic circuits without knowing the constraints of the quantum hardware architecture on which they aim to execute the circuits. The developers may delegate to the transpilation process the task of converting the circuits. This is expected, to some extent, to foster ever increasing abstraction levels in quantum programming. Nonetheless, quantum algorithm development is still very much connected with the intrinsic properties of quantum physics. For this reason, the quantum operations in the logical circuits are, for the most part, the same operations found in the target hardware. As discussed below, a number of challenges have arisen in the transpilation arena.

For example, quantum algorithm developers do not necessarily know the constraints of the quantum hardware architecture where they aim to execute their quantum algorithms. Thus, the transpilations that are developed may be sub-optimal.

In a related vein, quantum algorithm developers do not necessarily know the outcome of the transpilation of their algorithms. Thus, a transpilation process may be a hit-or-miss evolution, with the developer trying various different transpilations to find one that produces the best outcome.

Further, multi-qubit operations can only be executed by neighbor physical qubits on target quantum hardware. Transpilation algorithms solve this by adding SWAP operations that move qubit states across the hardware until they reach neighbor qubits. However, this approach takes time, and consumes resources. Moreover, an excessive number of SWAP operations lead to deep and potentially noisy circuits.

Finally, poorly developed quantum algorithms may lead to poor transpilation outcomes. This is problematic since the algorithms represent the initial conditions for the transpilation heuristics to execute.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an architecture and operations according to one example embodiment.

FIG. 2 discloses a method according to one example embodiment.

FIG. 3 discloses a computing entity configured and operable to perform any of the disclosed methods, processes, and operations.

### DETAILED DESCRIPTION OF SOME EXAMPLE EMBODIMENTS

Some embodiments of the present invention generally relate to quantum computing. More particularly, at least some embodiments of the invention relate to systems, hardware, software, computer-readable media, and methods, for quantum computing transpilation processes.

In general, an embodiment of the invention may comprise a quantum assistant module, which may also be referred to herein simply as an ‘assistant,’ and associated functionality, that operates to help an algorithm developer identify opportunities for modifying their circuits in such a way as to benefit a transpilation process. In an embodiment, the quantum assistant uses one or more machine learning models trained to recognize quantum algorithm gate patterns, and to estimate their transpilation outcomes. The quantum assistant may offer both on-line guidance, such as when the algorithm is being developed through a circuit shown on a GUI (graphical user interface) for example, as well as off-line guidance, such as by way of the execution of an analytics functionality that shows a report with all suggested circuit modifications.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a developer may be provided, during circuit development, with insights as to circuit modifications which, when incorporated into the circuit prior to transpilation, may result in improved transpilation. An embodiment may enable more efficient and effective circuit development and transpilations by providing a developer with predicted transpilation outcomes before transpilation is actually performed. An embodiment may integrate transpilation considerations into a circuit development process to enable development of circuits and algorithms to improve the effectiveness and efficiency of the subsequent transpilation processes. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. INTRODUCTION AND CONTEXT FOR AN EMBODIMENT OF THE INVENTION

Although it is expected that quantum computing (QC) will become more widely available in the near future, there is no consensus so far about which QC architectures or technologies will prevail. There is consensus, however, that classical computation will remain an integral part of quantum workloads, both from control and management perspectives as well as from an algorithmic perspective.

In the current NISQ (Noisy Intermediate-scale Quantum computing) era, hybrid algorithms that combine quantum and classical computation by design have been developed as candidates to demonstrate quantum advantage over classical algorithms. It is expected that such hybrid algorithms will form the basis of complex hybrid computation workloads in the future. One or more embodiments of the invention may be implemented in environments that include classical computing infrastructure that is integrated with a quantum computing infrastructure. However, orchestrating hybrid workloads across co-existing QC architectures is a challenging task. Aspects related to reliability, execution time, and ultimately costs of operation may determine which architecture is the most beneficial for each type of quantum computing workload. In an embodiment, one element in choosing an optimal QC architecture is the transpilation step. In general, transpilation is a process that converts a quantum circuit, which may be the equivalent of an algorithm in a high-level programming language, into another circuit that satisfies the hardware restrictions of the target platform where the circuit is to be executed. This may be thought of as the equivalent of machine code, or machine language, using native instructions and registers.

Quantum algorithm developers may write their logic circuits without knowing the constraints of the quantum hardware architecture where they aim to execute the circuits. In such an approach, the developers may delegate, to the transpilation process, the task of converting the circuits. This is expected, to some extent, to foster ever increasing abstraction levels in quantum programming. Nonetheless, quantum algorithm development is still very much connected with the intrinsic properties of quantum physics. For this reason, the quantum operations in the logical circuits are, for the most part, the same operations found in the target hardware.

In more detail, transpilation considers topological aspects of the hardware and overall noise in the system to find optimal mappings from logical to physical circuits. Since transpilation may be implemented via heuristic algorithms, the initial conditions, that is, the logical circuit, may directly determine the quality and speed of transpilation outcomes.

### B. GENERAL ASPECTS OF SOME EXAMPLE EMBODIMENTS

In light of the foregoing, an embodiment of the invention is directed to algorithms that include some knowledge or awareness concerning the underlying architecture where the algorithm, or circuit, is expected to be executed. More specifically, one or more embodiments of the invention are directed to what may be referred to herein as “qAssist,” a quantum assistant module that may enable an algorithm developer to identify opportunities for modifying their circuits in such a way as to benefit the transpilation process. In an embodiment, the quantum assistant may use machine learning (ML) models trained to recognize quantum algorithm patterns, and to estimate the transpilation outcomes for those quantum algorithm patterns. In an embodiment, the assistant may offer both on-line guidance, for example, when the algorithm is being developed through a circuit shown on a GUI (graphical user interface), and off-line functionality by way of the execution of an analytics functionality that may generate and present, by way of a GUI for example, a report with some or all suggested circuit modifications.

### C. ASPECTS OF AN EXAMPLE ARCHITECTURE AND OPERATIONS

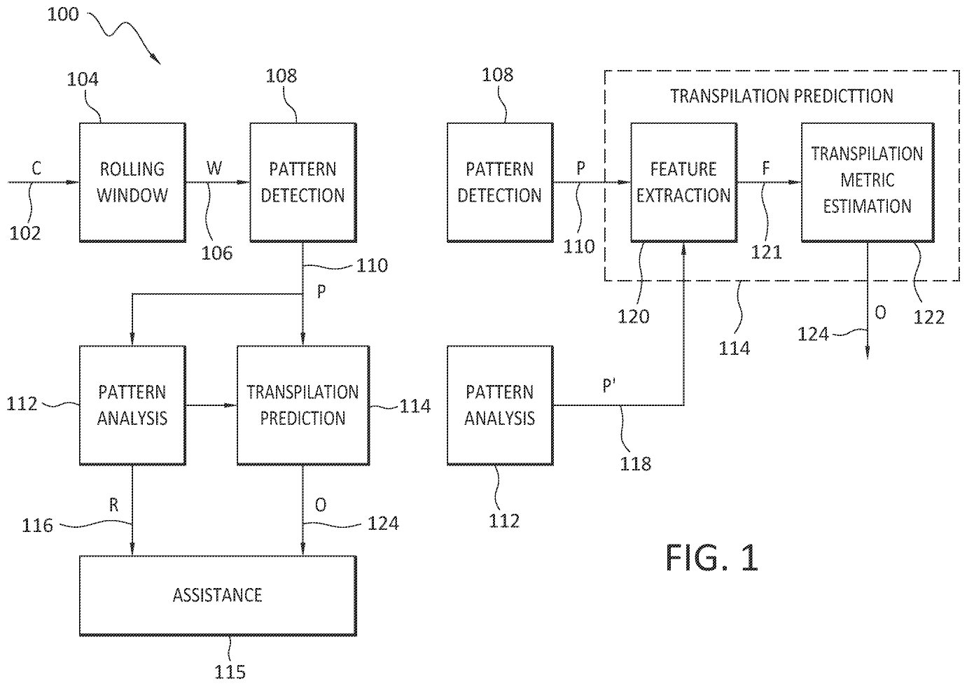

With particular reference to the example embodiment disclosed in FIG. 1, an architecture according to one example embodiment is generally denoted at 100. As shown in FIG. 1, a circuit ‘C’ 102 may be provided, such as by a developer for example, to a rolling window module 104 that obtains a section of the circuit ‘C’ 102. The circuit ‘C’ 102 may be provided in graphical format, such as when it is built via a graphical user interface, or in a code format, when it is built using a programming language. No particular format of the circuit ‘C’ 102 is necessarily required however.

In an embodiment, the rolling window module 104 may generate a window ‘W’ 106 corresponding to the referred section of the circuit ‘C’ 102. In this way, successive portions of the circuit ‘C’ 102 may be identified and assigned, as they are developed, to respective windows ‘W’ for further processing and analysis, as described in the example embodiments below.

The window ‘W’ 106 may be provided by the rolling window module 104 to a pattern detection module 108. In an embodiment, the pattern detection module 108 may identify that the circuit section in the window ‘W’ 106 is a known pattern ‘P’ 110, and may add metadata so indicating. The known pattern ‘P’ 110, and the associated metadata, may then be provided to both a pattern analysis module 112 and to a transpilation prediction module 114, as shown in FIG. 1. Note that a quantum gate pattern may be referred to herein simply as a ‘pattern.’

In an embodiment, the transpilation prediction module 114, which may comprise an ML model, may predict, using the ML model for example, transpilation metrics associated with the pattern ‘P’ 110, for a set of transpilation algorithms, such as the referred section of the circuit ‘C’ 102 for example, and associated parameters, that may be executable on a target quantum hardware architecture. Thus, the transpilation prediction module 114 may predict, for example, any, or all, of the following values for the entire circuit ‘C’ 102, or a portion of the circuit ‘C’ 102: [1] the total transpilation time; [2] the noise associated with the transpiled circuit; [3] the depth of the transpiled circuit; and [4] the total number of SWAP operations, in which information is swapped between qubits, in the transpiled circuit. The SWAP operations may be implemented using SWAP gates. In general, a SWAP gate may take in two qubits, and then switch their respective states so that the state of the first qubit becomes the state of the second qubit, and the state of the second qubit becomes the state of the first qubit.

In an embodiment, and with continued reference to FIG. 1, the pattern analysis module 112 may generate two outputs which may be provided to an assistance module 115. The first output may be a set 116 of one or more rules R that may indicate how the pattern ‘P’ 110 may be changed to conform with an applicable restriction. One example restriction, which may be embodied in a rule R, may indicate that a proposed circuit ‘C’ 102 operation X with qubits q1 and q2 cannot be performed directly because the qubits are not neighbors on the target hardware where the circuit ‘C’ 102 is to be executed. Based on this example rule R, and what is known about the circuit ‘C’ 102, the assistance module 115 may generate a suggestion to modify the circuit ‘C’ 102 to use pairs of qubits other than the pair q1/q2. This suggestion may be provided by the assistance module 115 to a developer who is constructing or modifying the circuit ‘C’ 102. In an embodiment, the developer is free to accept, or not, the suggestion provided. In any case however, the assistance module 115 may notify the developer of the implications, on transpilation for example, of adopting, or not, the suggestion. In an embodiment, the suggestion may be, for example, to simplify the circuit. To illustrate, some operations may lead to identities and thus can be removed from the circuit without negatively impacting circuit operation.

The second output of the pattern analysis module 112 may comprise a modified version of the pattern ‘P’ 110 that may result from simplification of the circuit associated with it. If the circuit is modified, a new pattern P′ 118 may be provided to the transpilation prediction module 114 to obtain transpilation metrics, as described earlier herein.

As further indicated on the right hand side of FIG. 1, an embodiment of the transpilation prediction module 114 may comprise two submodules, namely, a feature extraction submodule 120, and a transpilation metric estimation submodule 122. In an embodiment, the feature extraction submodule 120 may identify and extract features ‘F’ 121 from the circuit patterns such as the pattern ‘P’ 110 and the new pattern P′ 118. Those features ‘F’ 121 may then be provided to the transpilation metrics estimation submodule 122. In an embodiment, the transpilation metrics estimation submodule 122 may then generate a set of output metrics O 124, which may be based on the features ‘F’ 121.

In an embodiment, the set of rules 116, and the transpilation output metrics O 124, may then be provided to the assistance module 115. The assistance module 115 1 may then compile and aggregate the inputs and build suggestions for the quantum algorithm developer. It is noted that quality metrics of quantum hardware may be accessed via interfaces provided by quantum vendors, though such quality metrics of quantum hardware may not be considered during the development of the algorithms. In contrast, some embodiments of the invention may consider quality metrics in connection with the performance of an algorithm development process.

In an embodiment, the assistance module 115 may operate in an on-line mode, and an off-line mode. In the on-line mode, suggestions generated by the assistance module 115 may displayed to a developer, possibly by way of a GUI, as the algorithm is being developed. This approach may have the advantage that the developer can modify the circuit for each rolling window 104.

In the off-line mode, the algorithm developer may trigger a function, such as by way of a software library call or via a button or other selectable element on a user interface, that runs all operations of the assistant module 115, and a report may be displayed and/or otherwise provided to the developer that shows all suggestions at once. Following are some example suggestions that may be generated by an assistant module 115—these are provided only by way of illustration and are not intended to limit the scope of the invention in any way:
“Operation X cannot be executed between q1 and q3 without SWAPs. Your best options are (q1, q2) and (q1, q4).”
“Estimated transpilation time for this pattern, with the selected transpilation algorithm, is 500 ms.”
“The estimated noise of the transpiled version of this pattern, with the selected transpilation algorithm, is of the order of 10e-01.”
“The estimated execution time of the transpiled version of this pattern, with the selected transpilation algorithm, is 10 ms.”
“The estimated depth of the transpiled circuit is beyond the decoherence time of the target hardware. Consider breaking your circuit.”
“The selected transpiler yields more noise than transpiler XYZ.”
“Too many operations use qubit q3, which is the noisiest on the target hardware. Your best options are (q1 and q4).”
“This set of operations will incur too many SWAPs. Consider using more neighbor qubits (check hardware topology).”

### D. FURTHER DISCUSSION

One or more embodiments of the invention may possess various useful features and aspects. Following is a non-exhaustive list of examples. As will be apparent from this disclosure, one or more embodiments may possess various useful features and aspects. A non-exhaustive list of examples of such features and aspects is set forth below.

An embodiment may serve to provide a quantum algorithm developers with knowledge about the constraints of the quantum hardware architecture where they aim to execute their quantum algorithms.

An embodiment may serve to provide a quantum algorithm developer with knowledge, insights, and predictions, about the outcome of the transpilation of their quantum algorithms.

An embodiment may be directed to transpilation algorithms that add SWAP operations that move qubit states across the hardware until they reach neighbor qubits, so as to avoid, or otherwise deal with, a circumstance where multi-qubit operations can only be executed by neighbor physical qubits on target quantum hardware.

An embodiment may avoid the need for the excessive number of SWAP operations that may otherwise lead to deep and potentially noisy circuits.

An embodiment may improve the development of quantum algorithms that may otherwise lead to poor transpilation outcomes, as the algorithms may represent the initial conditions for the transpilation heuristics to execute.

An embodiment may comprise an assistant to provide on-line and off-line suggestions for quantum algorithm developers to improve their algorithms in such a way to achieve better results on target quantum hardware.

An embodiment may comprise a quantum gate pattern detection process that connects with an engine that predicts transpilation outcomes of the detected patterns.

An embodiment may comprise a process by which modifications of the circuit being developed are suggested to algorithm developers as they are developing the algorithms.

An embodiment may comprise a process by which analytics reports can be requested showing predicted transpilation outcomes of the quantum gate patterns detected by this invention.

An embodiment may comprise a process by which transpilation algorithms, and associated parameters, are suggested to algorithms developers during the development of the algorithms or via the analytics reports.

### E. EXAMPLE METHODS

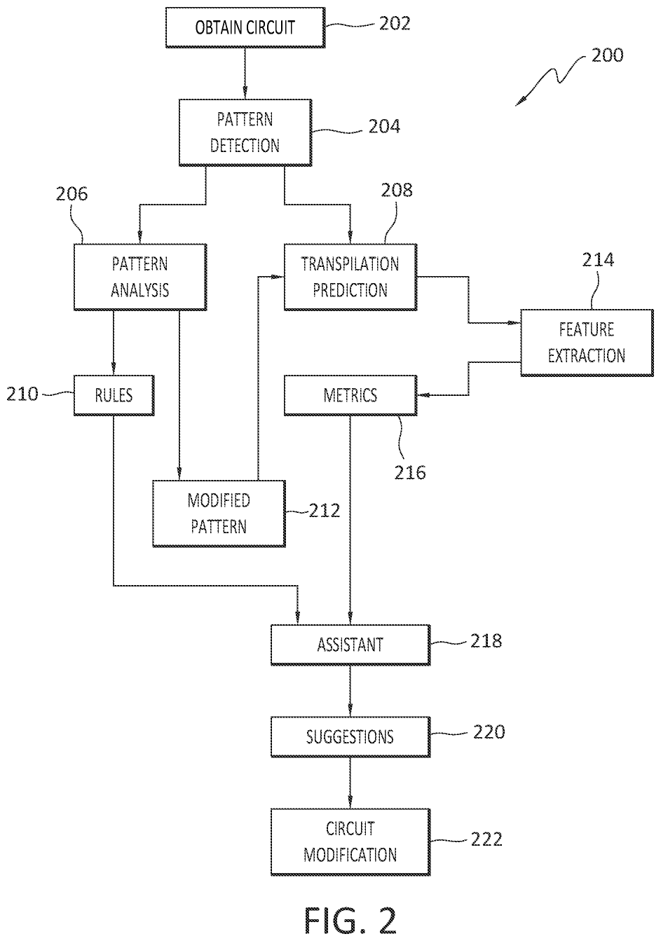

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

With attention now to FIG. 2, a method according to one example embodiment is denoted generally at 200. In an embodiment, the method 200 may performed in whole or in part by, and/or at the direction of, an assistance module, examples of which are disclosed herein. As noted earlier in the example of FIG. 1, an assistance module may be an element of an overall platform, such as the architecture 100 for example.

The example method 200 may begin when a portion of a circuit, that may be under development, is obtained 202. A pattern detection operation 204 may then be performed to identify one or more patterns in the circuit portion. When a pattern has been detected 204, the pattern may be provided to a pattern analysis module for pattern analysis 206, and may be provided to a transpilation prediction module for generation of one or more predictions 208 regarding a transpilation process involving that pattern.

In more detail, the pattern analysis module may, as a result of having analyzed the pattern, output 210 a set of rules indicating how the pattern may be changed, such as to improve transpilation for example, while maintaining conformance with any established restrictions and guidelines. The pattern analysis module may also identify portions of the pattern that may be simplified, and may thus output 212 a modified version of the pattern which comprises a simplified version.

In an embodiment, the modified version of the pattern may be supplied as an input to the transpilation prediction module. The transpilation prediction 208 may comprise extraction 214 of one or more features from the modified pattern. These extracted features may then be used by the transpilation prediction module as a basis to generate 216 various output metrics.

The rules generated 210 by the pattern analysis module, along with the metrics generated 216 by the transpilation prediction module, may then be provided 218 to an assistant. The assistant may use these inputs to generate 220 one or more suggestions as to how the pattern may be modified to improve transpilation performance. The suggestions, in turn, may be provided to a developer for implementation of one or more circuit modifications 222.

Note that the method 200 may be performed recursively to process each pattern of a group of patterns that make up a circuit. When the various patterns of the circuit have been evaluated, and corresponding circuit modifications implemented, the circuit may then be transpiled. In an embodiment, metadata and other information generated as a result of this transpilation may be provided as inputs to a pattern analysis modules and/or to a transpilation prediction module for further refinement of the circuit that was transpiled.

### F. FURTHER EXAMPLE EMBODIMENTS

Following are some further example embodiments of the invention. These are presented only by way of example and are not intended to limit the scope of the invention in any way.

Embodiment 1. A method, comprising: detecting a quantum gate pattern in a quantum circuit; analyzing the quantum gate pattern; based on the analyzing, generating a set of rules and generating a modified quantum gate pattern that comprises a modification of the quantum gate pattern; based on the modified quantum gate pattern, generating a set of transpilation output metrics; and using the rules and the transpilation output metrics to generate a suggestion concerning modification of the quantum circuit.

Embodiment 2. The method as recited in any preceding embodiment, wherein in an online mode, the suggestion is provided to a developer as the quantum circuit is being constructed.

Embodiment 3. The method as recited in any preceding embodiment, wherein in an offline mode, a function is triggered that generates a group that contains all suggestions pertaining to modification of the quantum circuit, and the suggestion is included in the group.

Embodiment 4. The method as recited in any preceding embodiment, wherein after the suggestion is implemented in the quantum circuit, a transpilation performance concerning the quantum circuit is improved relative to a transpilation performance observed or expected if the suggestion had not been implemented.

Embodiment 5. The method as recited in any preceding embodiment, wherein set of transpilation output metrics is generated based in part on one or more features extracted from the modified quantum gate pattern.

Embodiment 6. The method as recited in any preceding embodiment, wherein the quantum gate pattern is a subset of the quantum circuit.

Embodiment 7. The method as recited in any preceding embodiment, wherein one of the rules specifies how the quantum gate pattern may be modified and still conform with an established restriction.

Embodiment 8. The method as recited in any preceding embodiment, wherein the modified quantum gate pattern comprises a simplification of the quantum gate pattern.

Embodiment 9. The method as recited in any preceding embodiment, wherein the transpilation output metrics comprise a prediction as to a transpilation outcome expected from transpilation of the modified quantum gate pattern.

Embodiment 10. The method as recited in any preceding embodiment, wherein the suggestion concerns a transpilation performance and/or a structure of the modified quantum gate pattern.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In general, embodiments may comprise classical, and/or quantum, hardware and/or software. Quantum hardware may include, for example, physical qubits and QPUs. Quantum circuits may comprise, for example, real and/or virtual qubits.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

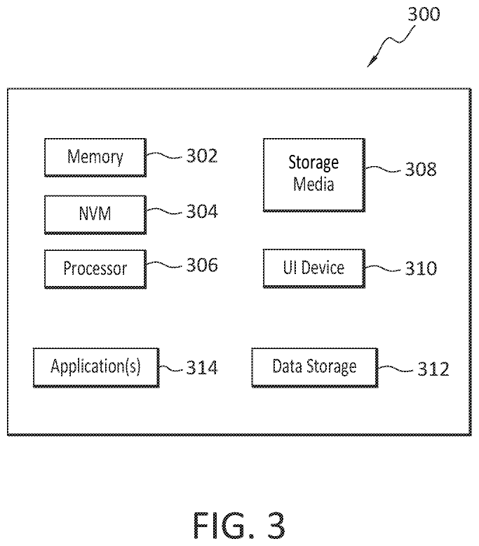

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
detecting a quantum gate pattern in a quantum circuit;
analyzing the quantum gate pattern;
based on the analyzing, generating a set of rules and generating a modified quantum gate pattern that comprises a modification of the quantum gate pattern;
based on the modified quantum gate pattern, generating a set of transpilation output metrics; and
using the rules and the transpilation output metrics to generate a suggestion concerning modification of the quantum circuit.

2. The method as recited in claim 1, wherein in an online mode, the suggestion is provided to a developer as the quantum circuit is being constructed.

3. The method as recited in claim 1, wherein in an offline mode, a function is triggered that generates a group that contains all suggestions pertaining to modification of the quantum circuit, and the suggestion is included in the group.

4. The method as recited in claim 1, wherein after the suggestion is implemented in the quantum circuit, a transpilation performance concerning the quantum circuit is improved relative to a transpilation performance observed or expected if the suggestion had not been implemented.

5. The method as recited in claim 1, wherein set of transpilation output metrics is generated based in part on one or more features extracted from the modified quantum gate pattern.

6. The method as recited in claim 1, wherein the quantum gate pattern is a subset of the quantum circuit.

7. The method as recited in claim 1, wherein one of the rules specifies how the quantum gate pattern may be modified and still conform with an established restriction.

8. The method as recited in claim 1, wherein the modified quantum gate pattern comprises a simplification of the quantum gate pattern.

9. The method as recited in claim 1, wherein the transpilation output metrics comprise a prediction as to a transpilation outcome expected from transpilation of the modified quantum gate pattern.

10. The method as recited in claim 1, wherein the suggestion concerns a transpilation performance and/or a structure of the modified quantum gate pattern.

11. A non-transitory storage medium having stored therein instructions that are executable by one or more hardware processors to perform operations comprising:
detecting a quantum gate pattern in a quantum circuit;
analyzing the quantum gate pattern;
based on the analyzing, generating a set of rules and generating a modified quantum gate pattern that comprises a modification of the quantum gate pattern;
based on the modified quantum gate pattern, generating a set of transpilation output metrics; and
using the rules and the transpilation output metrics to generate a suggestion concerning modification of the quantum circuit.

12. The non-transitory storage medium as recited in claim 11, wherein in an online mode, the suggestion is provided to a developer as the quantum circuit is being constructed.

13. The non-transitory storage medium as recited in claim 11, wherein in an offline mode, a function is triggered that generates a group that contains all suggestions pertaining to modification of the quantum circuit, and the suggestion is included in the group.

14. The non-transitory storage medium as recited in claim 11, wherein after the suggestion is implemented in the quantum circuit, a transpilation performance concerning the quantum circuit is improved relative to a transpilation performance observed or expected if the suggestion had not been implemented.

15. The non-transitory storage medium as recited in claim 11, wherein set of transpilation output metrics is generated based in part on one or more features extracted from the modified quantum gate pattern.

16. The non-transitory storage medium as recited in claim 11, wherein the quantum gate pattern is a subset of the quantum circuit.

17. The non-transitory storage medium as recited in claim 11, wherein one of the rules specifies how the quantum gate pattern may be modified and still conform with an established restriction.

18. The non-transitory storage medium as recited in claim 11, wherein the modified quantum gate pattern comprises a simplification of the quantum gate pattern.

19. The non-transitory storage medium as recited in claim 11, wherein the transpilation output metrics comprise a prediction as to a transpilation outcome expected from transpilation of the modified quantum gate pattern.

20. The non-transitory storage medium as recited in claim 11, wherein the suggestion concerns a transpilation performance and/or a structure of the modified quantum gate pattern.
